(19) United States
(12) Patent Application Publication
(10) Pub. No.: US 2017/0275493 A1
(43) Pub. Date: Sep. 28, 2017

(54) SPRAY COATING PROCESS, ARTICLE AND ASSEMBLY FOR APPLYING ANY OF A POLYURETHANE OR POLYUREA COATING TO A WIRE HARNESS, FLAT OR IRREGULAR METAL SURFACE OR PLASTIC INJECTION MOLDED PALLET

(71) Applicant: Oria Collapsibles, LLC, Auburn Hills, MI (US)

(72) Inventor: Miguel A. Linares, Bloomfield Hills, MI (US)

(21) Appl. No.: 15/459,803

(22) Filed: Mar. 15, 2017

Related U.S. Application Data
(60) Provisional application No. 62/311,885, filed on Mar. 22, 2016.

(51) Int. Cl. C09D 175/04; C09D 175/02; B05D 7/02; B05D 1/02; B05D 7/14

(52) U.S. Cl. CPC C09D 175/04; B05D 1/02; B05D 7/14; B05D 7/02; C09D 175/02

(57) ABSTRACT

A process and related assembly for applying a fast curing plastic spray coating to a substrate article having a specified shape and size with an exposed surface. The coating can include any polyurethane or polyurea composition and incorporating a fast curing catalyst which, upon delivery to a pneumatically charged nozzle, providing for aerated application from the nozzle upon the exposed surface. The spray coating further includes a cure time of between 5-10 seconds from aerated delivery and can be applied to any of a wire harness, metal surface or injection molded plastic pallet. In the specific instance of a wire harness coating. In the instance of a wire harness article, a plurality of branches terminate in end connectors, the coating providing insulating and fire-protection to the underlying harness.

### CROSS-REFERENCE TO RELATED APPLICATIONS

This Application claims the benefit of U.S. Provisional Application 62/311,885 filed on Mar. 22, 2016, the contents of which is incorporated herein in its entirety.

### FIELD OF THE INVENTION

The present invention relates generally to a spray coating process, article and assembly for applying any of a polyurethane or polyurea coating to a variety of articles including at least aligned pluralities of individually coated wires, flat or irregular metal surfaces or plastic injection molded pallets. The outer plastic coating is can be applied with or without the prior application of a base coat to enhance adhesion or gripping of the outer coating to the underside base material.

### BACKGROUND DESCRIPTION OF THE RELEVANT ART

The prior art is documented with examples of spray coating assemblies, such as associated with the coating of pallet and other articles. Examples of these include each of the spray applicating process and production assembly of Linares, U.S. Pat. No. 8,176,869, as well as the pallet construction with multi-surface bonding plasticized spray of Linares, U.S. Pat. No. 8,813,660.

Additional examples include the an injection molding system for overmolding compressible cordage as described in U.S. Pat. No. 8,535,034 to Hellberg. Also shown is the molded electrical apparatus wire set of Cortes Roque, US 2011/0177720 in which a polyurethane bonding material applied between an outer surrounding sheath associated with a plurality of wires and a molded portion of the wire set.

Davis, U.S. Pat. No. 8,413,914, teaches a method and apparatus for electrostatically spraying a plural component fast set polymer. A spray gun and at least two connected hoses are provided, with a proportioner connected to an end of the at least two hoses and a high voltage generator electrically and pneumatically in communication with the spray gun. The electrostatic spray system will allow for a fast set polymer to be imparted with electrical charge after mixing of a first and second component in a spray head thereof prior to expulsion via a nozzle to a grounded target that is being coated with the electrostatic spray coating.

### SUMMARY OF THE PRESENT INVENTION

The present invention discloses a process and related assembly for applying a fast curing plastic spray coating to a substrate article having a specified shape and size with an exposed surface. The coating can include any polyurethane or polyurea composition and incorporating a fast curing catalyst which, upon delivery to a pneumatically charged nozzle, providing for aerated application from the nozzle upon the exposed surface. The spray coating further includes a cure time of between 5-10 seconds from aerated delivery and can be applied to any of a wire harness, metal surface or injection molded plastic pallet. Additional features include a base adhesion coat pre-applied prior to application of the spray coat.

Also disclosed is a combination fast curing plastic spray coating and substrate article, the article having a specified shape and size with an exposed surface.

In the instance of a wire harness article, a plurality of branches terminate in end connectors, the coating providing insulating and fire-protection to the underlying harness. Additional versions of articles include such having a metal surface article exhibiting any of painted, primer/base coated, sanded/etched, grooved, raw punched, clean perforated or stamped shapes. Other versions of coated articles also include pallet articles exhibiting any of a coated top deck and/or underside runner surfaces.

A related assembly for coating a surface with a built-up polyurethane or polyurea composition includes a nozzle for providing aerated and pressurized spray delivery of the composition in a fluidic and atomized delivered fashion upon a delivery surface. Gripper and locator portions are provided for holding an article exhibiting the delivery surface during spray application, following which the grippers/locators are sequentially repositioned prior to successive spray applications. Also disclosed are dedicated fluidic and pneumatically delivery lines communicated with the spray nozzle.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first prior art illustration of a conventional wire harness for use in any type of vehicular, industrial or other application and including individual bunched pluralities of strands with end-supported connectors;

FIG. 2 is a succeeding illustration depicting hand taping of the harness in order to maintain the integrity of the branching pluralities of wires;

FIG. 3 is an illustration of a first example of the spray coating process, article and assembly in which a nozzle is employed for applying any of a polyurethane or polyurea coating to the selected wire branch, the coating being applied along any length of the wiring up to the end positioned connector, the composition of the coating further such being that cure time can be reduced downward to 5-10 seconds from spray application;

FIG. 4 is an illustration similar to FIG. 2 of a plastic coated wire harness according to one non-limiting embodiment of the present inventions;

FIG. 5 is an enlarged view of the branching end sections of the harness in FIG. 4 and which illustrates the fast curing outer coating as being of any durometer ranging between flexible to rigid, such as depending upon the desired environment and/or application of the harness;

FIG. 6 is an enlarged end view of a spray coated branch of the wire harness and further depicting the spray coating capable of being applied to any extent along the harness branch up to the adjoining edge of the connector;

FIGS. 6A-6C are further illustrations of an example of a plastic spray coated wire harness created according to the process and assembly of the present inventions;

FIG. 7 is an illustration of a metal surface article and depicting the fast curing spray coating applied thereto, such as over an initial base coat for providing superior adhesion of outer coating to the substrate article, such as to the degree that a rib of the metal can be pre-located against a surface of the main body, without welding, and with the cured outer plastic coating structurally maintaining the rib in place thereafter;

FIG. 8 is a further illustration of a metal substrate according to a further variant with a spray coating applied thereto according to any thickness or composition, such applied over a base coat of a plastic to metal adhering composition;

FIGS. 9A-9G present a series of side profile views of both planar and irregular or apertured metal surfaces in a pre-applicating condition and associated with the plastic spray applicating process and assembly of the present inventions;

FIGS. 10A-10G are corresponding post-application illustrations of the built-up plastic spray coating and further illustrating selected aperture versions in which adhesion of overflow locations of the cured plastic spray coating around reverse surface aperture defining rim edges of the substrate material in certain instances dispense with the necessity of the adhesion promoting base coat;

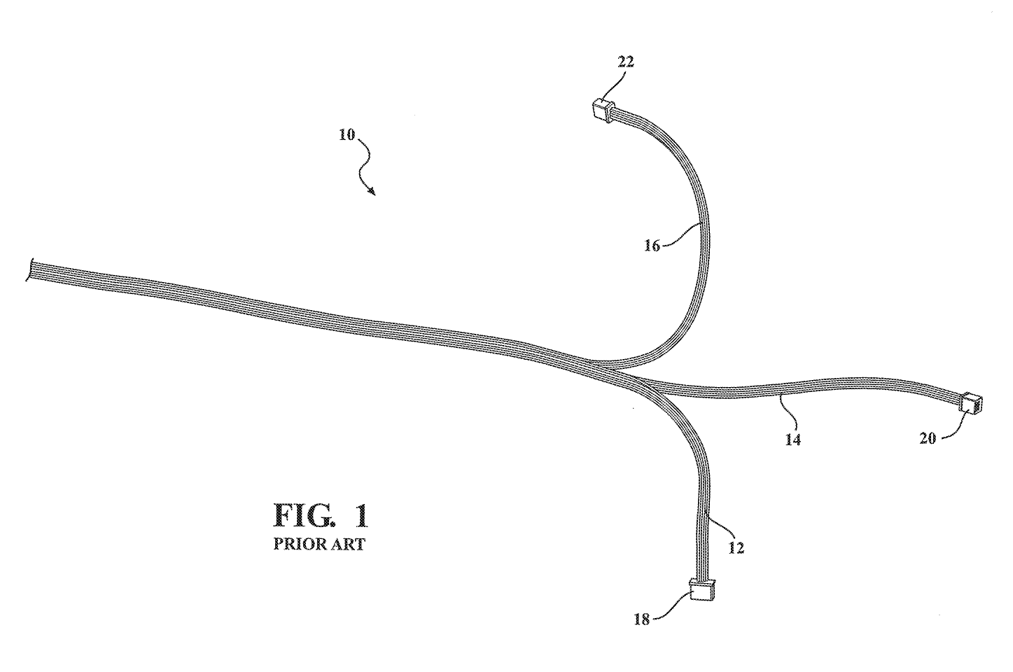

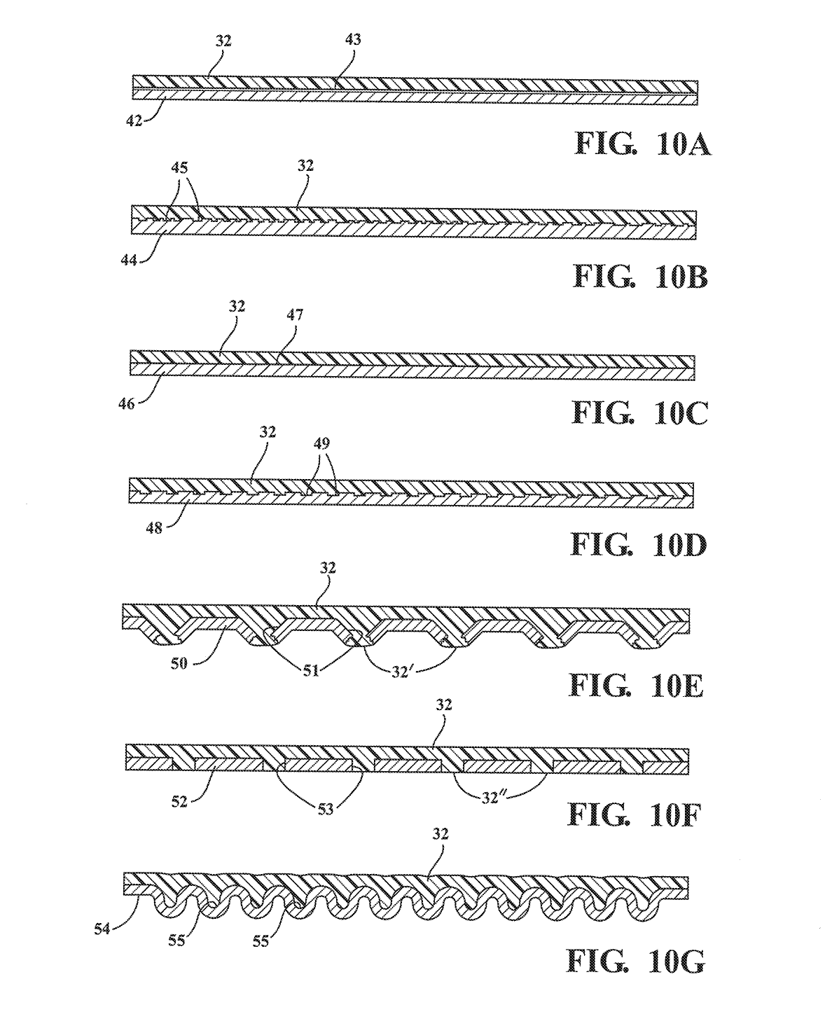

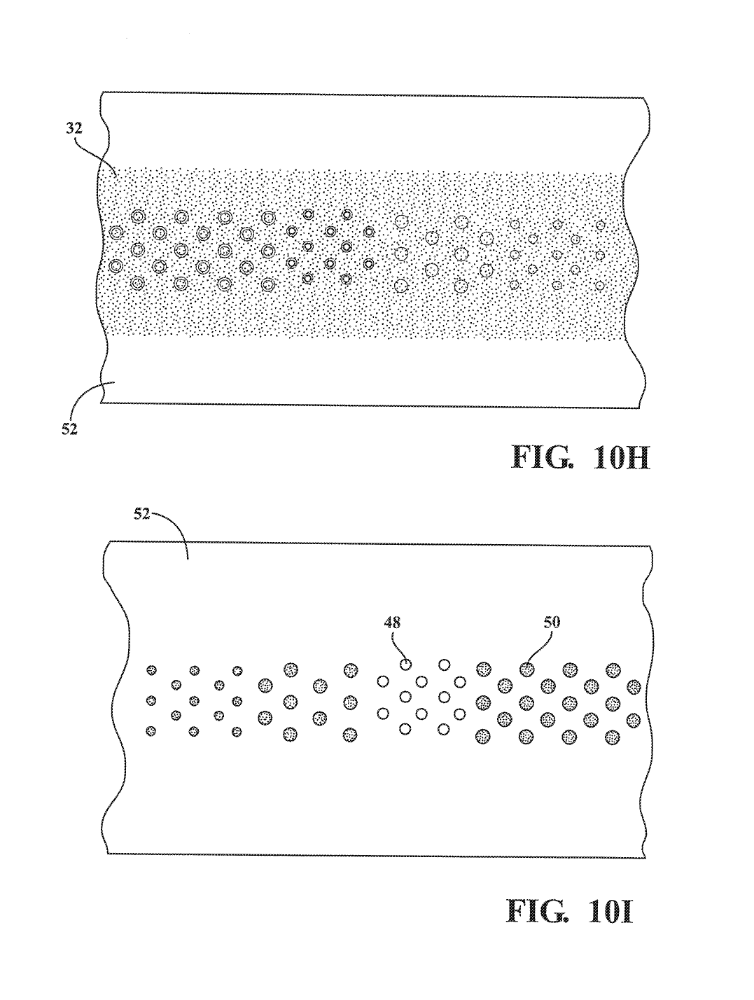

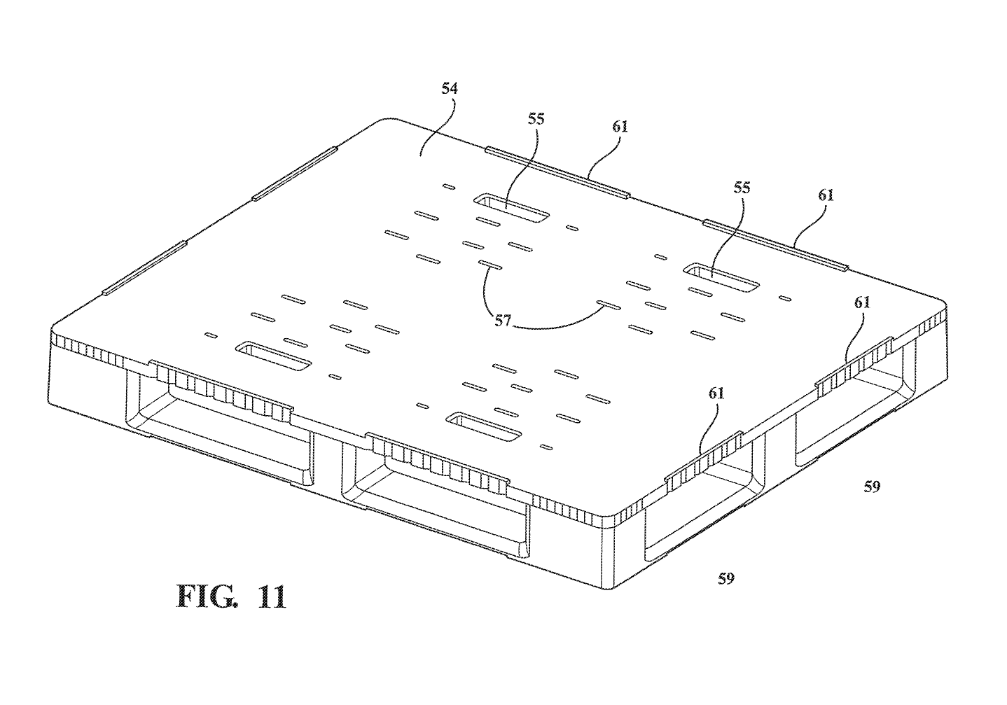

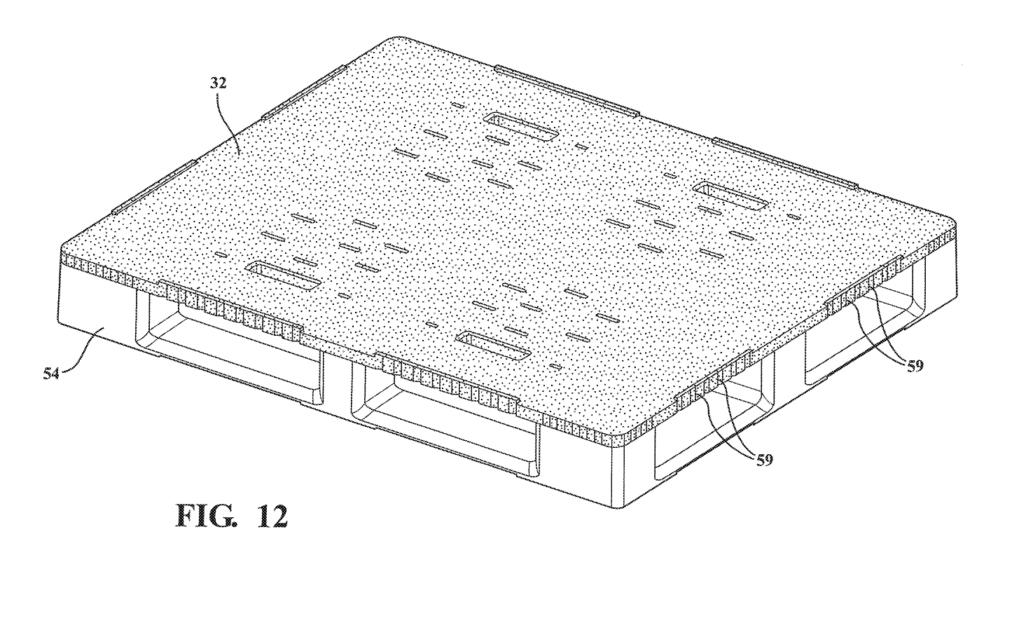

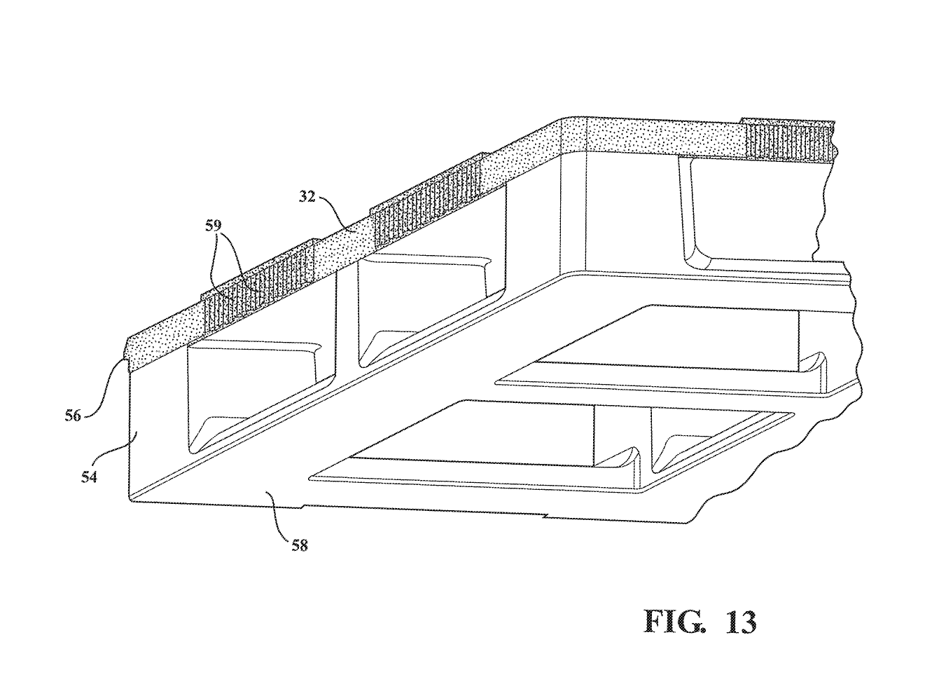

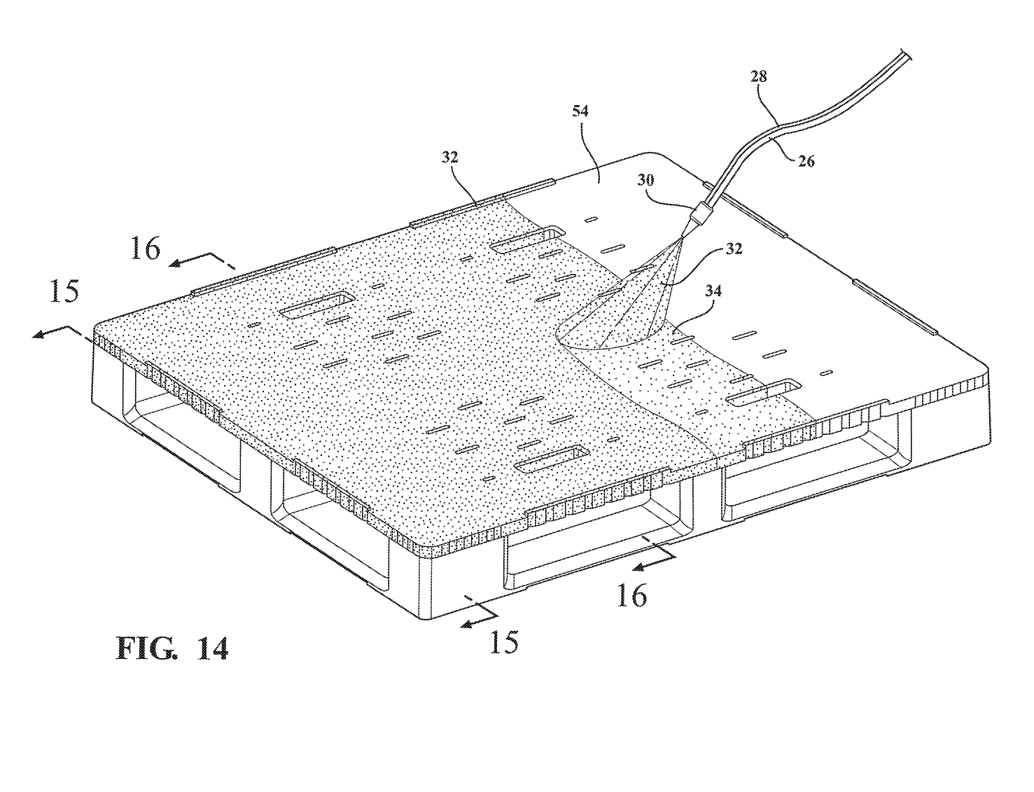

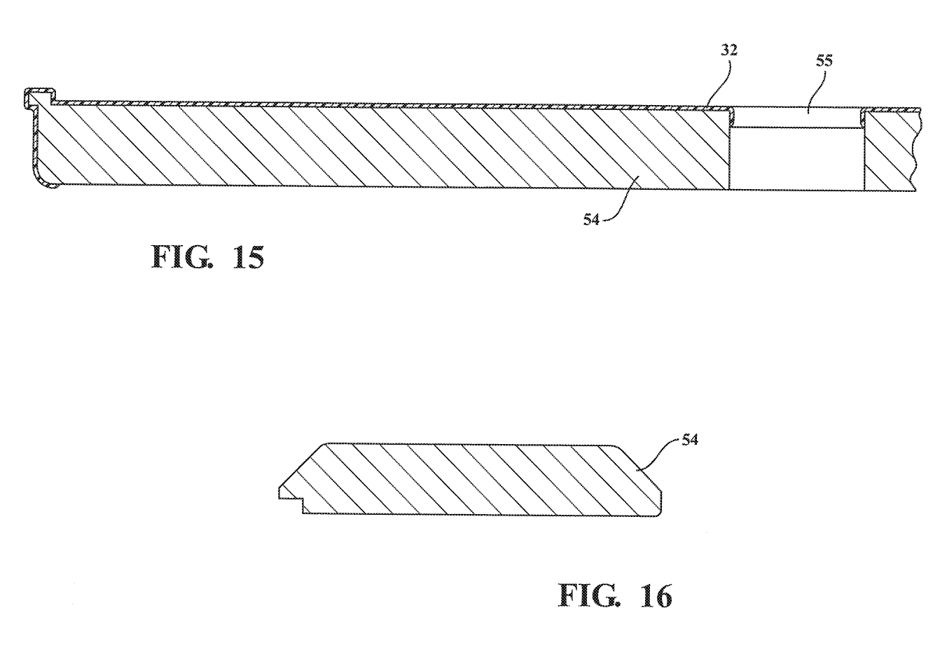

FIGS. 1OH-10I are a pair of front and reverse facing illustrations of an apertured metal article similar to FIGS. 10E-10G and to which is applied the fast cure plastic spray coating is applied;

FIG. 11 is a perspective view of a plastic injection molded pallet in use with a plastic spray coat application process according to a further embodiment of the present inventions;

FIG. 12 is a succeeding perspective view of the plastic spray coating according to a further embodiment in which the top deck of the injection molded pallet is coated in order to provide adequate frictional (skid resistant) properties when loaded with cargo;

FIG. 13 an enlarged underneath side perspective of the plastic spray coated pallet and better illustrating the perimeter edge profile of the adhering and fast curing coating of plastic material against the top and adjoining upper side edges of the pallet article;

FIG. 14 is a further illustration of the plastic spray applicating process and including a first adhesion promoting base coat applied to the deck surface of the pallet, following which a built-up plastic overcoat is applied to the pallet deck over the base coat; and

FIGS. 15 and 16 are a pair of cutaway views taken along lines 15-15 and 16-16, respectively of FIG. 14 and showing a pair of both end face proximate and interior cross sectional locations associated with the plastic coated upper deck of the injection molded pallet article.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first prior art illustration of a conventional wire harness for use in any type of vehicular, industrial or other application and including individual bunched pluralities of strands with end-supported connectors;

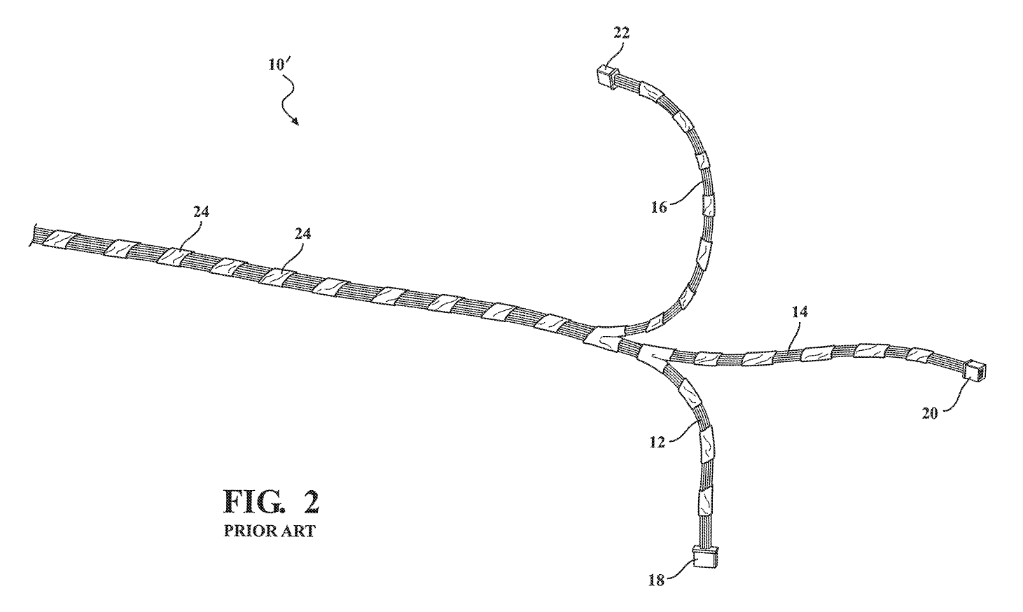

FIG. 2 is a succeeding illustration depicting hand taping of the harness in order to maintain the integrity of the branching pluralities of wires;

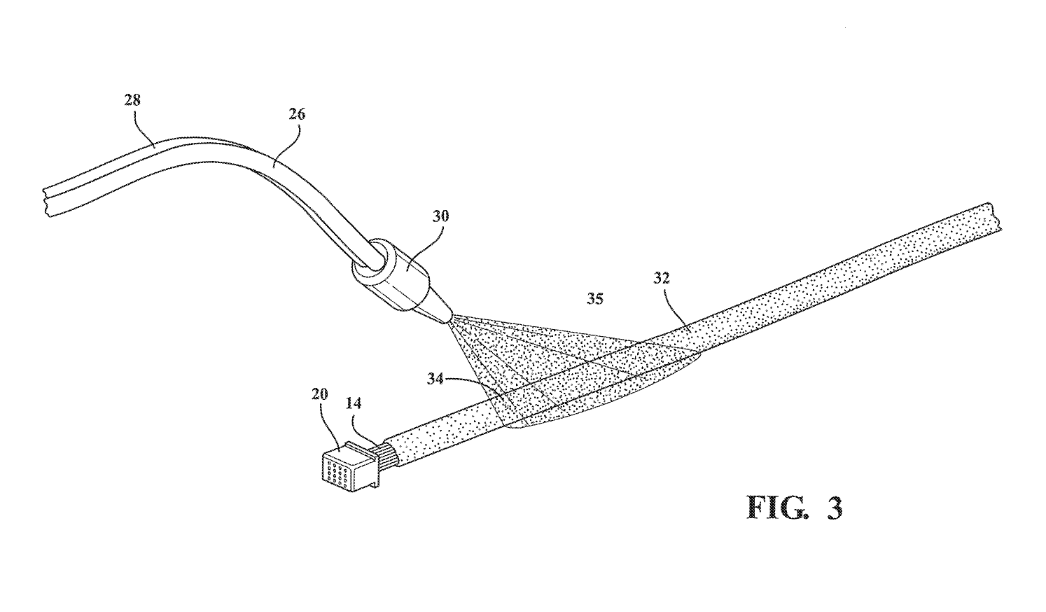

FIG. 3 is an illustration of a first example of the spray coating process, article and assembly in which a nozzle is employed for applying any of a polyurethane or polyurea coating to the selected wire branch, the coating being applied along any length of the wiring up to the end positioned connector, the composition of the coating further such being that cure time can be reduced downward to 5-10 seconds from spray application;

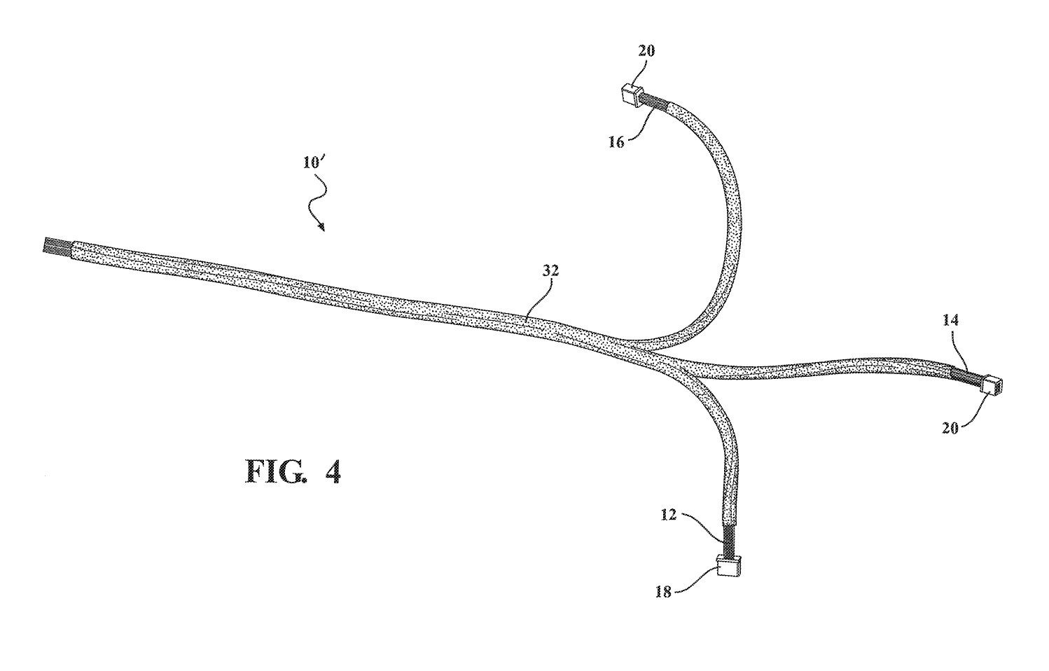

FIG. 4 is an illustration similar to FIG. 2 of a plastic coated wire harness according to one non-limiting embodiment of the present inventions;

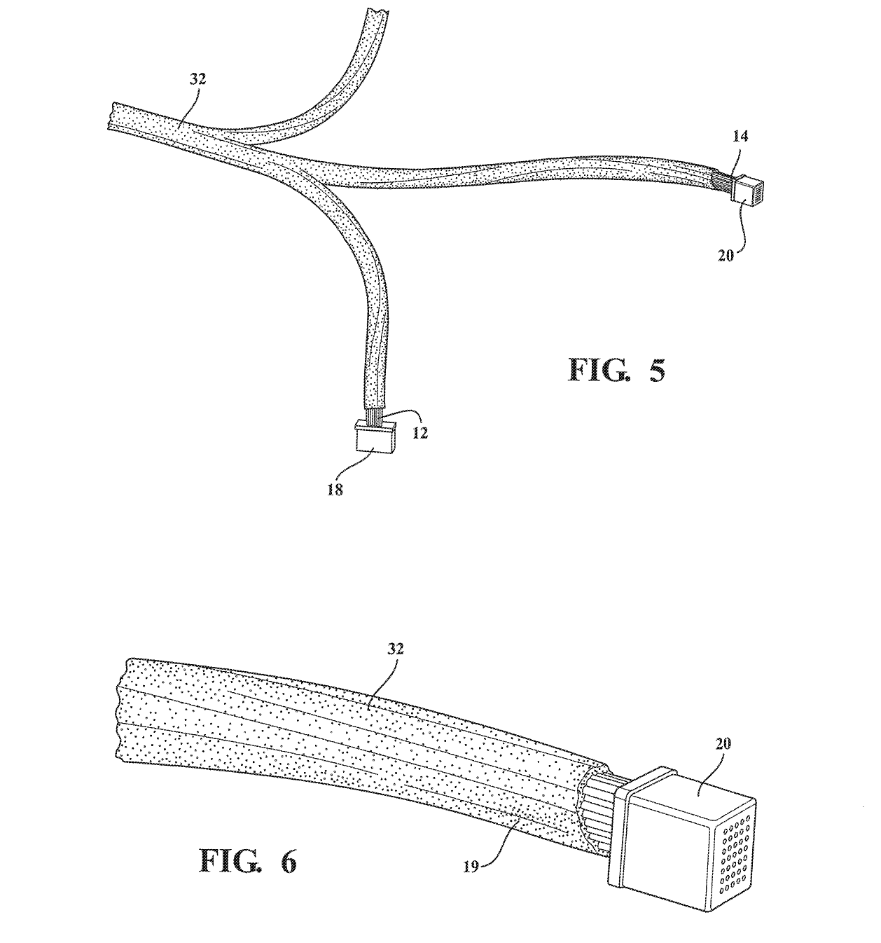

FIG. 5 is an enlarged view of the branching end sections of the harness in FIG. 4 and which illustrates the fast curing outer coating as being of any durometer ranging between flexible to rigid, such as depending upon the desired environment and/or application of the harness;

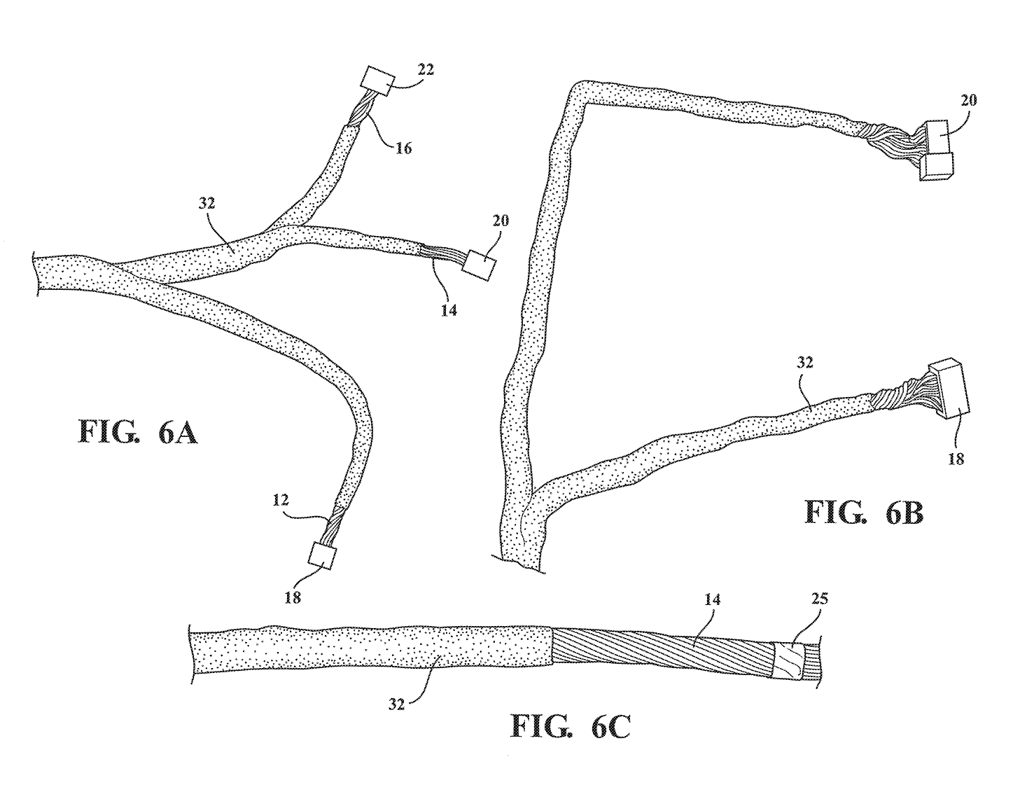

FIG. 6 is an enlarged end view of a spray coated branch of the wire harness and further depicting the spray coating capable of being applied to any extent along the harness branch up to the adjoining edge of the connector;

FIGS. 6A-6C are further illustrations of an example of a plastic spray coated wire harness created according to the process and assembly of the present inventions;

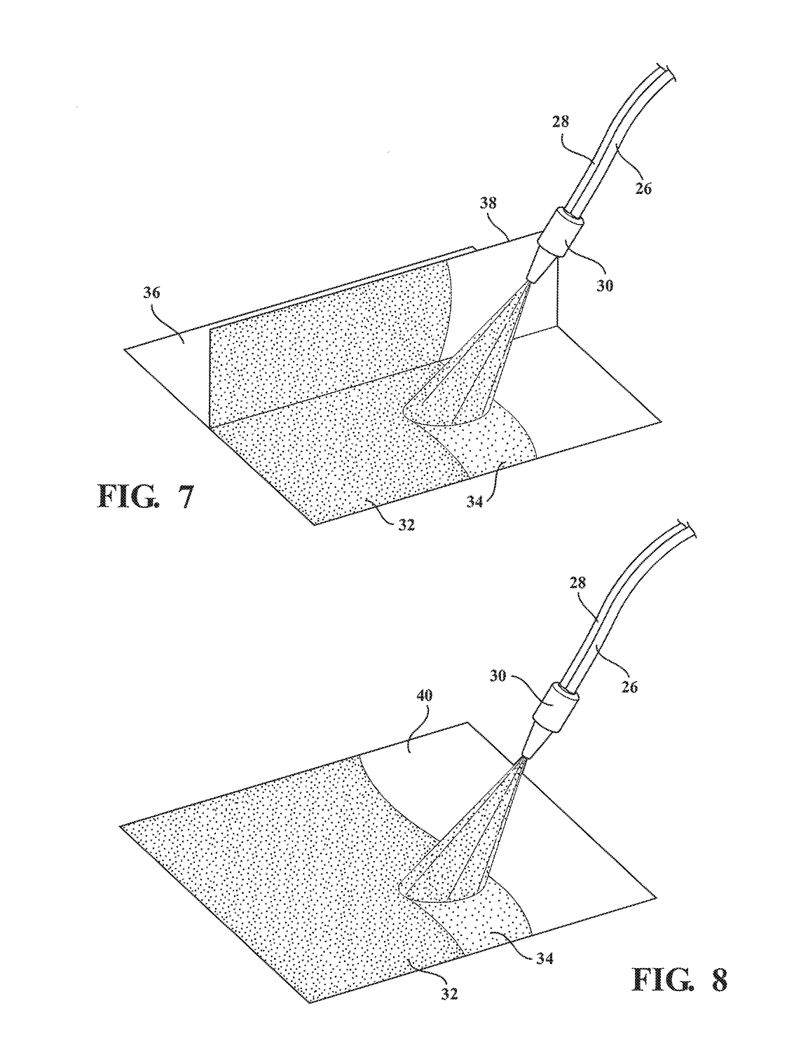

FIG. 7 is an illustration of a metal surface article and depicting the fast curing spray coating applied thereto, such as over an initial base coat for providing superior adhesion of outer coating to the substrate article, such as to the degree that a rib of the metal can be pre-located against a surface of the main body, without welding, and with the cured outer plastic coating structurally maintaining the rib in place thereafter;

FIG. 8 is a further illustration of a metal substrate according to a further variant with a spray coating applied thereto according to any thickness or composition, such applied over a base coat of a plastic to metal adhering composition;

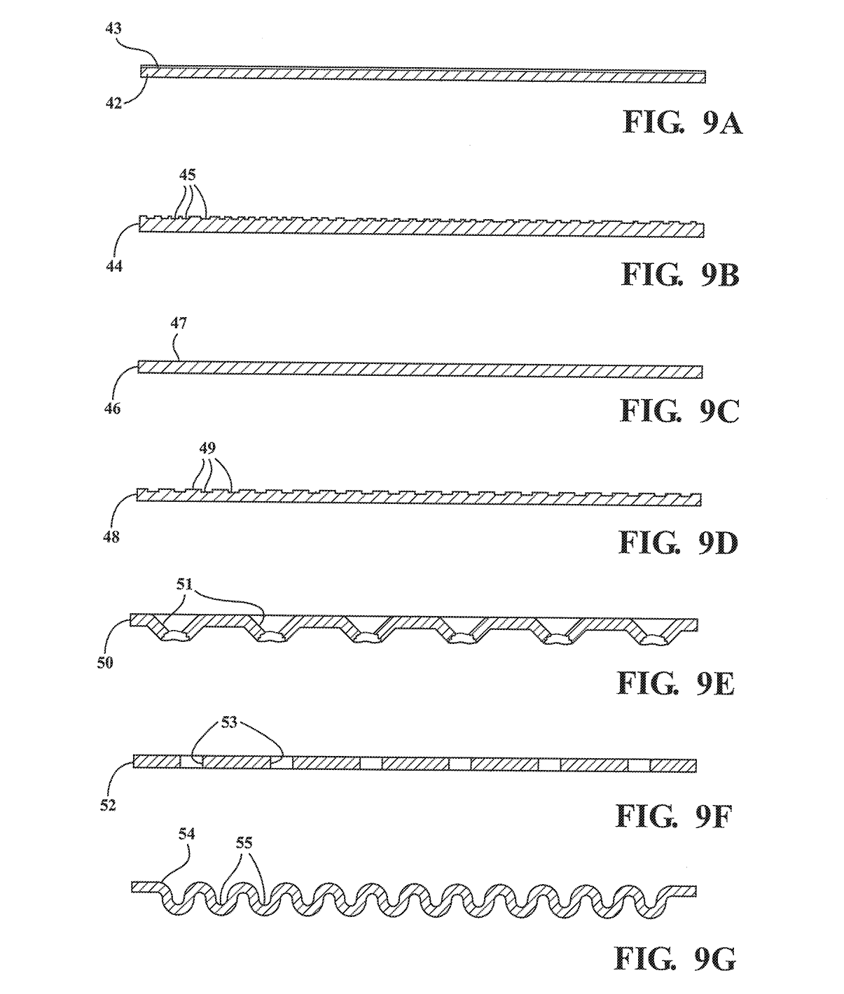

FIGS. 9A-9G present a series of side profile views of both planar and irregular or apertured metal surfaces in a pre-applicating condition and associated with the plastic spray applicating process and assembly of the present inventions;

FIGS. 10A-10G are corresponding post-application illustrations of the built-up plastic spray coating and further illustrating selected aperture versions in which adhesion of overflow locations of the cured plastic spray coating around reverse surface aperture defining rim edges of the substrate material in certain instances dispense with the necessity of the adhesion promoting base coat;

FIGS. 10OH-10I are a pair of front and reverse facing illustrations of an apertured metal article similar to FIGS. 10E-10G and to which is applied the fast cure plastic spray coating is applied;

FIG. 11 is a perspective view of a plastic injection molded pallet in use with a plastic spray coat application process according to a further embodiment of the present inventions;

FIG. 12 is a succeeding perspective view of the plastic spray coating according to a further embodiment in which the top deck of the injection molded pallet is coated in order to provide adequate frictional (skid resistant) properties when loaded with cargo;

FIG. 13 an enlarged underneath side perspective of the plastic spray coated pallet and better illustrating the perimeter edge profile of the adhering and fast curing coating of plastic material against the top and adjoining upper side edges of the pallet article;

FIG. 14 is a further illustration of the plastic spray applicating process and including a first adhesion promoting base coat applied to the deck surface of the pallet, following which a built-up plastic overcoat is applied to the pallet deck over the base coat; and

FIGS. 15 and 16 are a pair of cutaway views taken along lines 15-15 and 16-16, respectively of FIG. 14 and showing a pair of both end face proximate and interior cross sectional locations associated with the plastic coated upper deck of the injection molded pallet article.

### DETAILED DESCRIPTION OF THE PREFERRED EMBODIMENTS

With reference to the succeeding illustrations, the present inventions set forth herein apply to any of a variety of spray coating processes, articles and assemblies for applying any of a variety of fast curing polyurethane or polyurea coating to a variety of articles. The coatings disclosed herein are applied in a built-up fashion to the substrate articles, such as which can include, without limitation, any of aligned pluralities of individually coated wires (FIGS. 1-6), flat or irregular metal surfaces (FIGS. 7-10) and plastic injection molded pallets (FIGS. 11-16). As will be also described, the outer plastic coating is can be applied with or without the prior application of a base coat to enhance adhesion or gripping of the outer coating to the underside base material.

Prior to reference to the individual drawing figures, the universal application aspects of the present invention are directed to the ability to spray apply a plastic coating, such as generically defined as a polyurethane or pulyurea coating, via a high pressure and pneumatically pressurized spray nozzle, and to do so in such a fashion that a fast curing catalyst integrated into the plastic fluidic matrix causes the coating to cure in extremely an short time (e.g. in instances down to 5-10 seconds) following application onto the article.

As is also known, a polyurethane (PUR and PU) is a polymer composed of organic units joined by carbamate (urethane) links. While most polyurethanes are thermosetting polymers that do not melt when heated, i.e. thereby providing fire-resistant properties to the article being coated, other thermoplastic polyurethanes are also available. Polyurethane polymers are traditionally and most commonly formed by reacting a di- or polyisocyanate with a polyol. Both the isocyanates and polyols used to make polyurethanes contain on average two or more functional groups per molecule. Polyurethane products often are simply called “urethanes”, and by itself, may be used in the manufacture of nonflexible, high-resilience articles.

Consistent with the above-description of polyurethanes, a polyurea as generally known is a type of elastomer that is derived from the reaction product of an isocyanate component and a synthetic resin blend component through step-growth polymerization. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin.

As is further known, polyurea resin blends may be made up of amine-terminated polymer resins, and/or amine-terminated chain extenders. The amine-terminated polymer resins will not have any intentional hydroxyl moieties. Any hydroxyls are the result of incomplete conversion to the amine-terminated polymer resins. The resin blend may also contain additives, or non-primary components. These additives may contain hydroxyls, such as pre-dispersed pigments in a polyol carrier. Normally, the resin blend will not contain a catalyst(s).

When combined with the built-up spray applicating processes described herein, the properties of polyurethane and polyurea coatings can be transferred to other articles and assemblies, via the ability to create enduring thickness coatings about such articles and to do so in such a fashion that the plastic coating is both fast curing and does not peel away from the substrate article. It is also understood that (both proprietary and non-proprietary) versions of the plasticized coatings as described herein may incorporate fast curing catalysts to promote extremely fast curing of the plastic matrix once applied to the substrate article.

Certain variants of the process, assembly, and associated plastic compositions, also teach an initial base or undercoat application to the desired article, such also potentially including any known compositions such as disclosed above as well as additional proprietary compositions and which, depending upon the material construction of the article, can facilitate enhanced gripping or retention of the built up and fast curing plastic overcoat to the article. As will be also described, certain materials can be mechanically manipulated or reconfigured to provide enhanced gripping by the plastic overcoat, such that the base adhesion promoting coat may not be necessary.

Given the above, FIG. 1 is a first prior art illustration 10 of a conventional wire harness for use in any type of vehicular, industrial or other application, such including individual bunched pluralities of strands 12, 14, and 16 with associated and end-supported connectors 18, 20 and 22. FIG. 2 is a succeeding prior art illustration depicting hand taping, see at 24, of the harness, further at 10′, in order to maintain the integrity of the branching pluralities of wires.

As is known, spiral hand taping of the harness typically is required to be applied in a manual hand-winding fashion, such as is performed by workers on a factory floor. The harness shown in FIG. 2 is also shown with spaces or gaps between the individual windings 24, it be understood that additional applications may require that the total length of the harness and its associated branches be covered or encased within the outer (typically) electrical tape.

Proceeding now to FIG. 3, an illustration is shown of a first example of the spray coating process, article and assembly of the present inventions and in which a pneumatically charged or pressurized fluid line, defined as plastic flowing application line 26 and parallel running pneumatic line 28. These lines combine to contemporaneously feed an end supported mixing and spray applicating nozzle 30, such exhibiting a known construction. The nozzle 30 mixes the plasticized coating with the pressurized air for applying, in a pressurized, atomized and pneumatic aerated fashion, any of a polyurethane or polyurea coating composition 32 (such again including either proprietary or non-proprietary recipe mixtures as above-described) to a selected pluralities of wires integrated into a wire branch 14.

As shown, the coating can be applied along any length of the wiring up to the end positioned connector 20. As further previously described, and according to the fast setting composition utilized, the composition of the coating is further such that cure time can be reduced downward to 5-10 seconds from spray application. These factors, combined with the relatively small cost associated with the plasticized spray component and the associated tooling, provide both time and cost savings over manual wrapping of the harness with tape as again shown in FIGS. 1-2. As will be also discussed, the ability to securely and safely coat/encase the entire length of the harness provides additional protections to the harness given its environmental application and other considerations.

Without limitation, a base or initial coat 34 can also be optionally pre-applied to the wiring prior to the subsequent application of the main built-up spray coating 32 (the coating 32 while being shown in FIG. 3 being understood to constitute a second layer following pre-application of the base layer 34), such also being capable of being delivered from the same or a different spray nozzle. For purposes of FIG. 3, a boundary line 35 is depicted between the initial 34 and built-up 32 spray coatings, the selected illustration being understood to represent that more than one layer of spray coatings may be applied in any desired order.

Although not shown, any suitable jig or assembly can be utilized for holding the harness in place during the spray application process and, further given the very short cure times required for sufficient hardening of the applied coating, the gripping portions of the associated jig can be continuously repositioned over recently coated sections of the harness in a sequential fashion during progressive coating thereof. In further variants not using the base coat 34, the interstitial spacing between the aligning or wound strands of each wire harness (see also FIGS. 6A-6C) can provide adequate surface area for effectuating bonding thereabout and therebetween the outer plastic coating 32.

As also previously described, the base coat 34 can include any other proprietary composition (such integrating any aspects of a polyurethane, polyurea and/or other plasticized coating and which may also include any one or more of a grit or adhesion promoting ingredient). The base coat 34 can further be provided to any suitable minimal thickness necessary in order to create a substratum adhesion coating to the wiring prior to application of the built-up plastic overcoat 32. Additional envisioned variants can include the base coat 34 being substituted by any of a dip coating or other applicating process and, when necessary, in order to create a suitable bonding surface for the plastic over-coating 30.

FIG. 4 is an illustration similar to FIG. 2 of the plastic coated wire harness 10′ according to one non-limiting embodiment of the present inventions. The harness 10′ can be completely spray coated to any desired thickness. It is also envisioned that the plasticized coating 32 can incorporate any desired recipe or mixture in order to provide a desired durometer or flexibility to the finished article. In the case of the wire harness design, the engineering of a desired degree of flex to the completed harness (via adjustment to the durometer rating of the plastic over coating) can be useful in maintaining the integrity of the assembly, in particular in instances where proximately located moving parts may otherwise impinge or sever a displaced or miss-positioned harness. As such, the ability to modify the outer durometer rating of the spray coating recipe can also be utilized as an alternative to clips or other fasteners for securing the harness in place.

FIG. 5 is an enlarged view of the branching end sections of the harness in FIG. 4 and which again illustrates the fast curing outer coating (e.g. again down to as little as 5-10 seconds) as being of any durometer ranging between flexible to rigid, such as depending upon the desired environment and/or application of the harness. As further referenced by the enlarged end view of FIG. 6, the illustrated spray coated branch of the wire harness further depicts the spray coating capable of being applied to any extent along the harness branch 14 up to the adjoining edge of the connector 20. Reiterating the above description, the ability to modify the durometer rating of the plastic outer coating (such as which can further be applied to any thickness from a few mils up to ¼″ to ½″ or more) may also best maintain the integrity of the structural network design of the harness 10′ and by maintain the relative positioning of the extending ends 18, 20 and 22 of the connectors in some desire fashion.

FIGS. 6A-6C are further illustrations of an example of a plastic spray coated wire harness created according to the process and assembly of the present inventions. Reiterating the above description, the wire branches can be pre-configured in any manner desired (such as through the assisting use of any jig or other assembly) and prior to spray application of the sealing and flexurally or rigidly supporting coating. FIGS. 6A-6B illustrate the branches arranged in desired orientations associated with a desired installation environment, with FIG. 6C illustrating a straight-away section of a given plurality of wire strands segregated into a branch or section 14 which is partially coated at 32 and which may also include additional ties or bands 25 for pre-locating support prior to and during spray coating.

As further previously described, the thermoset aspects of the outer polyurethane or polyurea coating also provide enhanced insulating and fire-proof protection to the underlying wire harness. In this fashion, the wire harness variant (as with the metal surfaced variant to the subsequently described), can be utilized in any of a wide range of vehicular applications not limiting to automotive, aircraft, marine, agricultural and the like. Other home/residential, commercial or industrial applications are also possible.

Proceeding to FIG. 7, an illustration is shown at of a metal surface article, at 36, and depicting the fast curing spray coating, again at 32, applied thereto, such as over an initial base coat (again 34) and for providing superior adhesion of outer coating to the substrate article. In the particular illustration, a rib of metal 38 is depicted in perpendicular extending fashion relative to the flat surface of the main article 36. By way of illustration, the rib 38 of the metal can be pre-located against a surface of the main body, through the use of a suitable jig or holding mechanism and without previously welding, and with the fast cured outer plastic coating 32 structurally maintaining the rib 38 in place thereafter against the surface of the main metal article 36 and without concern of fracture or breakoff of the rib 38 owing to the structurally supporting properties of the coating.

As with the previously described variant with the harness, the base coat 34 can provide sufficient gripping properties for bonding the outer plastic coating 32 to the surfaces of the article 36/38, such further not limited to any type of metal or associated alloy. As further depicted in FIG. 8, a further illustration of a metal substrate article 40 is shown according to a further variant with a spray coating 32 applied thereto according to any thickness or composition, such applied over a base coat, again at 34, of a plastic to metal adhering composition.

As previously described, any type or configuration of sheet metal (the material composition of which can include any of an aluminum, brass, tin, copper, steel, lead, etc.) can be utilized without limitation and, as also previously indicated, any type of polyurethane or polyurea coating can be applied to any thickness ranging from a few mils upward. The properties of the base coating 34 are again repeated and can include any polymeric base ingredient to which can be combined any type of aggregate, grit or other component which can increase adhesion properties of the outer plastic coat 32, in particular instances when applied to a smooth surface exhibited by the selected article 36, 38 or 40.

Proceeding to FIGS. 9A-9G, a series of side profile views are presented of both planar and irregular or apertured metal layers/surfaces in a pre-applicating condition and associated with the plastic spray applicating process and assembly of the present inventions. These include each of a metal layer 42 with a painted surface 43, a metal layer 44 with a primer/promoter or other surface etching profile 45, a metal layer 46 which is sanded or etched, at surface 47, a metal layer 48 with an irregular grooved surface 49, a further irregular metal profile 50 with raw punched or three dimensional holes, at 51, a metal layer 52 with clean perforated holes 53 and, finally, a non-perforated metal layer 54 exhibiting a plurality of repeating stamped profiles 55.

FIGS. 10A-10G are corresponding post-application illustrations of the built-up plastic spray coating, again at 32, applied to each of the shapes depicted in FIGS. 9A-9G. With particular reference to selected aperture versions, again FIGS. 10E and 10F, adhesion of overflow locations of the cured plastic spray coating is depicted around reverse surface aperture defining rim edges of the substrate material, such in certain instances dispenses with the necessity of the pre-application of the adhesion promoting base coat 34. This is further best depicted in FIG. 10E by reverse face through flow portions 32′ of the plastic coating associated with the three dimensional punch out holes 51 and, further in FIG. 10F by additional flow through locations 32″ associated with the clean perforated holes of profile 52.

The additional irregular profile 52 of FIG. 10G provides many of the same benefits of the aperture versions, in this particular instance by increasing the gripping surface of the underlying metal article to which the plastic build up over coating 32 can be spray applied with the need of a base coat. FIGS. 10H-10I are a pair of front and reverse facing illustrations of an apertured metal article similar to FIGS. 10E-10G (and such as for example being previously depicted at 52 in FIG. 10F), to which the fast cure plastic spray coating is applied to selected aperture profiles shown at 48/50 as well as non-apertured irregular surfaces consistent with any of those illustrated or described, it being further understood that the examples of FIGS. 9-10 are intended to depict non-limiting examples configured metal surfaced materials to which the plastic material can be adhered in a structurally bonding and built up fashion and in order to impart physical and structural characteristics to the underlying article which extend beyond the environmental or coating aspects of the plasticized and fast drying spray.

Proceeding to FIG. 11, a perspective view of a plastic injection molded pallet, such as known in the existing art, is shown at 54 in use with a plastic spray coat application process according to a further embodiment of the present inventions. As will be described, the pallet can be of any injection molded plastic material, typically rigid and in order to provide necessary structural properties for supporting the weight of the cargo load (not shown) placed thereupon.

As further understood, the typical smooth upper deck surface of the pallet 54 can provide a disadvantage when loading cargo from a sideways direction, the speed and angle of delivery of which can otherwise tend to slide off of the upper deck surface of the pallet if care is not taken. Very often, such issues occur when the pallets are pre-placed upon a conveyor and the cargo is delivered from forklift or other sideways-delivered fashion. As further shown, pluralities of larger hand-hold sized apertures 55 and smaller slot shaped drainage aperture 57 may be configured into the upper deck of the pallet.

FIG. 12 is a succeeding perspective view of the polyurethane/polyurea fast curing recipe coating plastic spray coating 32 according to a further embodiment in which the top deck of the injection molded pallet 54 is coated in order to provide adequate frictional (skid resistant) properties when loaded with cargo, such further seeping through and coating the interior of the pallet through its upper deck apertures 55/57. FIG. 13 an enlarged underneath side perspective of the plastic spray coated pallet and better illustrating the perimeter edge profile, further at 56, of the adhering and fast curing coating of plastic material 32 against the top and adjoining upper side edges of the pallet article 54.

As was described in reference with preceding embodiments, the perimeter edge profile 56 of the coating 32 can assist in preventing peel-away of the plastic coating, and such as in combination with flow through of the plastic relative to the various apertures or hand-holds (again at 55/57 in FIG. 11) configured within the deck surface of the pallet article. As best again shown in FIG. 13, the plastic coating can also adhere to toothed or dental edge profiles, see at 59, associated with the upper adjoining side rim edge of the pallet 54, such as further are associated with molded top edge restraining locations 61.

FIG. 14 is a further illustration of the plastic spray applicating process and including a first adhesion promoting base coat, again at 34, applied to the deck surface of the pallet, following which a built-up plastic overcoat 32 is applied to the pallet deck 54 over the base coat. Viewing FIGS. 12-14 concurrently, it is understood that the base 34 or over built up spray coating 32 can be applied to some or all of the surfaces of the pallet, including further the sides or bottom. It is further understood that lower runners 58 depicted in FIG. 13 can also be coated and that the fast curing recipe of the plastic material (proprietary or otherwise) can include any type of entrained grit or aggregate to facilitate both adherence to the injection molded surface of the pallet (or intervening base coat 34) as well as in providing adequate frictional resistance in respond to any sliding motion component associated with the cargo placed upon the pallet article.

Finally, FIGS. 15 and 16 are a pair of cutaway views taken along lines 15-15 and 16-16, respectively of FIG. 14 and showing a pair of both end face proximate and interior cross sectional locations associated with the plastic coated upper deck 54 of the injection molded pallet article. These figures are intended to demonstrate that the plastic over coating of the injection molded pallet can be associated with any or all surfaces of the article, such typically including at least the top deck thereof but not limited in any instance to any such surface of the supporting pallet structure (the interior cross section of FIG. 16 remaining uncoated in this example however which can be likewise coated by an interior application of the polyurethane/polyurea based recipe.

Accordingly, the above discloses a variety of applications for the application of a spray built up coating of a polyurethane/polyurea based material to any article. The coating, as previously described, can include any proprietary or non-proprietary recipe and which, upon being applied in a built-up fashion, provides both fast curing and structural support to the underlying article which can include any automotive, aircraft, home, marine, agricultural or other application. As further previously described, the fast curing coating also provides enhanced insulation and fire proof aspects (due to the thermoset nature of the composition).

Having described my invention, other and additional preferred embodiments will become apparent to those skilled in the art to which it pertains, and without deviating from the scope of the appended claims:

I claim:

1. A fast curing plastic spray coating applied to a substrate article, comprising:
the article having a specified shape and size with an exposed surface; and
the coating including any polyurethane or polyurea composition and incorporating a fast curing catalyst which, upon delivery to a pneumatically charged nozzle, providing for aerated application from the nozzle upon the exposed surface.

2. The spray coating as described in claim 1, further including a cure time of between 5-10 seconds from aerated delivery.

3. The spray coating as described in claim 1, the article including any of a wire harness, metal surface or injection molded plastic pallet.

4. The spray coating as described in claim 1, further comprising a base adhesion coat pre-applied prior to application of the spray coat.

5. A combination fast curing plastic spray coating and substrate article, comprising:
the article having a specified shape and size with an exposed surface; and
the coating including any polyurethane or polyurea composition and incorporating a fast curing catalyst which, upon delivery to a pneumatically charged nozzle, providing for aerated application from the nozzle upon the exposed surface.

6. The combination as described in claim 5, further including a cure time of between 5-10 seconds from aerated delivery.

7. The combination as described in claim 5, the article including any of a wire harness, metal surface or injection molded plastic pallet.

8. The combination as described in claim 5, further comprising a base adhesion coat pre-applied prior to application of the spray coat.

9. The combination as described in claim 7, further comprising a wire harness article including a plurality of branches terminating in end connectors, the coating providing insulating and fire-protection to the underlying harness.

10. The combination as described in claim 7, further comprising a metal surface article exhibiting any of painted, primer/base coated, sanded/etched, grooved, raw punched, clean perforated or stamped shapes.

11. The combination as described in claim 7, further comprising a pallet article exhibiting any of coated top deck and/or underside runner surfaces.

12. A structurally supporting and fast setting coating composition for application to a wire harness assembly, the harness including any plurality of elongated strands communicating with an end connector, composition, comprising:
any of a polyurethane or polyurea based material delivered as a pressurized spray in a fluidic and atomized delivered fashion upon a delivery surface associated with the wire harness assembly and so that the material establishes a built-up coating; and
a catalyst integrated into a recipe of the fluidic material for effectuating fast drying of the material.

13. The coating composition as described in claim 12, further comprising dedicated fluidic and pneumatically delivery lines communicated with a spray nozzle for applying the composition.

14. The coating composition as described in claim 12, further including a cure time of between 5-10 seconds from aerated delivery of the pressurized spray.

15. The coating composition as described in claim 12, further comprising a base adhesion coat pre-applied prior to application of the spray coat.
